(19) United States
(12) Patent Application Publication
(10) Pub. No.: US 2007/0115348 A1
(43) Pub. Date: May 24, 2007

(54) Method and system for automatic scheduling of a conference

(75) Inventors: Martin Eppel, Santa Clara, CA (US); Aaron Tong, San Jose, CA (US); Mukul Jain, San Jose, CA (US); Labhesh Patel, San Francisco, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/260,057

(22) Filed: Oct. 27, 2005

(51) Int. Cl. H04N 7/14; H04M 3/42

(52) U.S. Cl. 348/14.08; 379/202.01

(57) ABSTRACT

A method and a system for automatic scheduling of a conference in a network are provided. A conference is scheduled and organized, based on agenda and conference session parameters. The conference is scheduled on the basis of the signal received by the user input device, specifying the state of the conference sessions. Sessions are modified on the basis of the alerts generated. The participants of the conference are automatically informed about the modification of the sessions.

### BACKGROUND OF THE INVENTION

1. Field of Invention

Embodiments of the invention relate in general to conferencing. More specifically, the embodiments of the invention relate to methods and systems for automatic scheduling of a conference.

2. Description of the Background Art

Modern communication techniques enable multiple users at remote locations to communicate simultaneously over conference calls. A conference call can be organized as a teleconference, a videoconference, and so forth. A teleconference may be supported by audio, video, and data transmission devices such as a telephone, radio, television, computer, and so forth. A videoconference may be supported by both telephony and video devices, such as a web cam and a close-circuit television.

One aspect of setting up a conference is to select and notify those people who are invited to participate, or required to attend, a conference. Characteristics of the conference are also established. The characteristics can include the time, place and description of the conference. For example, in a teleconference, a starting time and description of the teleconference may be provided to prospective participants. A list of the participants might be used as a group email list for notification. Individuals who receive the notification can respond by email or with other types of programs such as via a calendar or a scheduling program to indicate that they will or will not attend.

While this approach can work well for a single conference with a few participants, traditional approaches can run into difficulties when, for example, multiple conferences need to be established and the number of participants starts to grow. Other factors or characteristics of the multiple conferences may not be easily handled. This may include how to reschedule conferences quickly, in real time, when a conference exceeds its original time.

### BRIEF DESCRIPTION OF THE DRAWINGS

FIG. 1 illustrates a network environment for automatic scheduling of a conference, in accordance with various embodiments of the invention.

FIG. 2 illustrates a block diagram depicting a user interface and a processing system in accordance with an embodiment of the invention.

FIG. 3 illustrates basic features of a graphical user interface in a preferred embodiment of the invention.

FIG. 4 illustrates a flowchart of a method for automatic scheduling of a conference, in accordance with an embodiment of the invention.

FIG. 5 illustrates a flowchart of a method for the generation of alerts, in accordance with an embodiment of the invention.

### DETAILED DESCRIPTION OF EMBODIMENTS OF THE INVENTION

Various embodiments of the invention, provide methods for structuring and organizing a conference. This structuring and organization is performed on the basis of parameters assigned to the agenda of the conference and to the sessions in the agenda. Some sessions may be “static,” i.e., in a fixed relationship to an agenda time or to a time, for example a start time, of other sessions. In contrast, some other sessions can be “dynamic”, i.e., sessions are not fixed with respect to another session or agenda parameter value. For example, a static session may be a session that is an introduction to another session, a question-and-answer session that follows a main topic session, a break-out session for business discussion related to a main topic session, a session for technical discussion, and so forth.

Agenda parameters such as the agenda name, start time, participants, location, etc., can be inherited by sessions as global parameters. Session parameters such as session name, start time, location, duration, whether static or dynamic, etc., can be assigned individually to each session. Session inherited parameters can include a list of all participants for the agenda. For example, all participants in an agenda “participants parameter” can be included to be invited to the conference introduction session and to a lunch session by default. Any modifications to the participants for these two sessions can be done by editing the inherited agenda parameter for each session.

A session can be allocated a start time with respect to other sessions. A session's start time parameter can also be automatically assigned on the basis of an algorithm (e.g., each session lasts 45 minutes), or by using a set of predefined parameters, etc. The allocated timings of the conference sessions can be modified on the basis of a signal received by a user input device, which is controlled by a conference moderator such as when a command line interface (CLI) or graphical user interface (GUI) is employed.

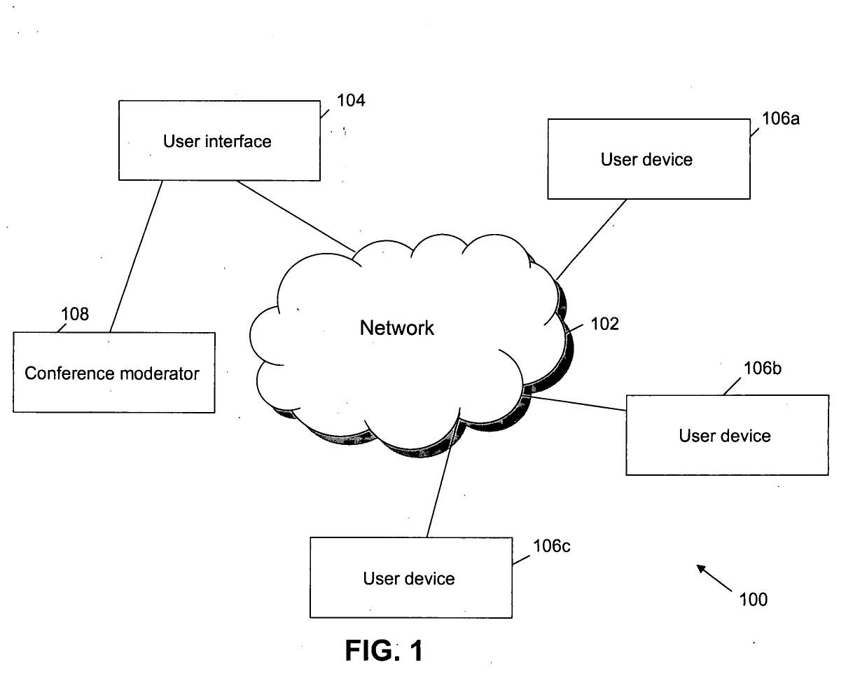

FIG. 1 illustrates a network environment 100 for automatic scheduling of a conference, in accordance with various embodiments of the invention. Network environment 100 includes a network 102, a user interface 104, user devices 106, and a conference moderator 108. Examples of network 102 include a Local Area Network (LAN), a Metropolitan Area Network (MAN), a Wide Area Network (WAN), a fixed line, a wireless, the Internet, etc. In general, any number and type of communication link, protocol, topography, devices and processes can be used, as desired.

The conference is structured and organized by user interface 104. User interface 104 can use a computer system or other processing system to arrange a Voice Over Internet Protocol (VOIP) teleconference. In an embodiment of the invention, user interface 104 comprises a processing system that can be controlled by conference moderator 108. Using user interface 104, conference moderator 108 can automatically, or through a combination of automatic and manual steps, act to set up, modify and manage the teleconference. Conference moderator 108 can be a participant in the conference.

Participants of the conference can be connected to network 102 through user devices 106. Examples of user devices 106 can be any computing devices that enable communication. These include VOIP devices, wireless phones, cell phones, Personal Digital Assistant (PDAs), fixed line phones, and so forth.

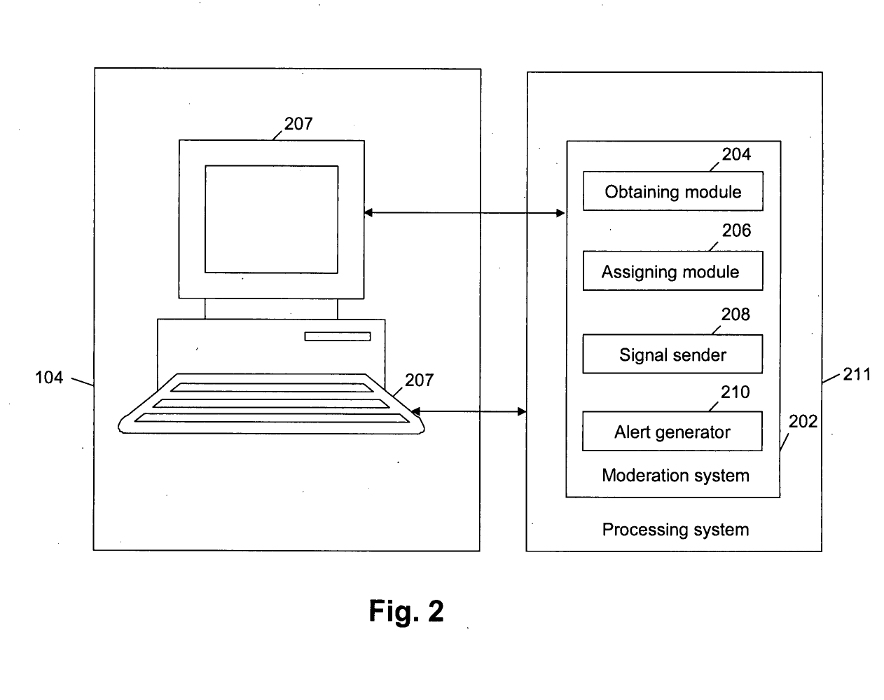

FIG. 2 illustrates a block diagram depicting user interface 104, in accordance with an embodiment of the invention. In a preferred embodiment, user interface 104 includes a display screen 207 and a user input device such as a keyboard 205. Note that any other type of input and output devices can be used. For example, a mouse, a trackball, touch pad, light pen, motion detector, etc., can be used as a user input device. Similarly any type of display screen, image projection, three-dimensional display device, etc., can be used. In some cases, as with voice input and output, a physical input and/or output device may not be necessary.

In an embodiment of the invention, user interface 104 includes a processing system 211. Processing system 211 includes basic components (not shown) such as a processor, random access memory (RAM), read-only memory (ROM), input/output (I/O) ports, etc. Any type of suitable processing system with more or less components, or components of different types can be used. Processing system 211 is used to execute functionality that can be in software, hardware, firmware, etc., or in combinations of such functional embodiments.

In FIG. 2, processing system 211 includes a moderation system 202. In accordance with an embodiment of the invention, moderation system 202 can include an obtaining module 204, an assigning module 206, a signal sender 208, and an alert generator 210. In an embodiment of the invention, obtaining module 204 has multiple units for obtaining various agenda parameters, session parameters and subscriptions from the participants of the conference, and communicating to them their session timings. Various agenda parameters include the length of the agenda, the name of the conference room, conference credentials, and so forth. Credentials can include a conference identifier (ID), password, personal identification number (PIN) or other security information. Various session parameters include the conference style, the list of conference participants, the time and duration of the availability of the conference participants, and so forth. A subscription indicates the presence of a participant in the conference session that is of interest to the participant. According to an embodiment of the invention, the conference style can indicate whether a conference session is an introduction, a question and answer session, or free style. A free-style session could include a business or technical presentation. In an embodiment of the invention, the session parameters can also include the communication address of the participants. The communication address can be used to inform the participants about the schedule of the conference, the beginning of a session, a modification in the schedule of the subscribed session, and to establish the conference between the participants. The communication address can include phone numbers, e-mail addresses, pager numbers, and so forth. Once the parameters are obtained by obtaining module 204, and the subscriptions by the participants of the conference for the session they are interested in, then assigning module 206 interacts with obtaining module 204, to assign the parameters to the agenda and the conference sessions. Thereafter, the participants of the conference are informed about their respective session timings.

Once the conference is organized and structured, and the participants notified about the respective sessions for which they have subscribed, a signal is generated by signal sender 208, to specify the beginning of a session, based on the allocated session time. The beginning of a session is associated with its list of participants, the conference style, the duration of the conference session, and so forth.

Signal sender 208 also interacts with alert generator 210. Alert generator 210 receives a signal from signal sender 208 when each of the sessions is close to its predetermined ending time, and when there is a change in the time of the availability of the participants and the availability of conference resources. Alert generator 210 generates a message to notify conference moderator 108 about the same. In an embodiment of the invention, conference moderator 108 modifies the conference session, if required, to adjust any unforeseen problems.

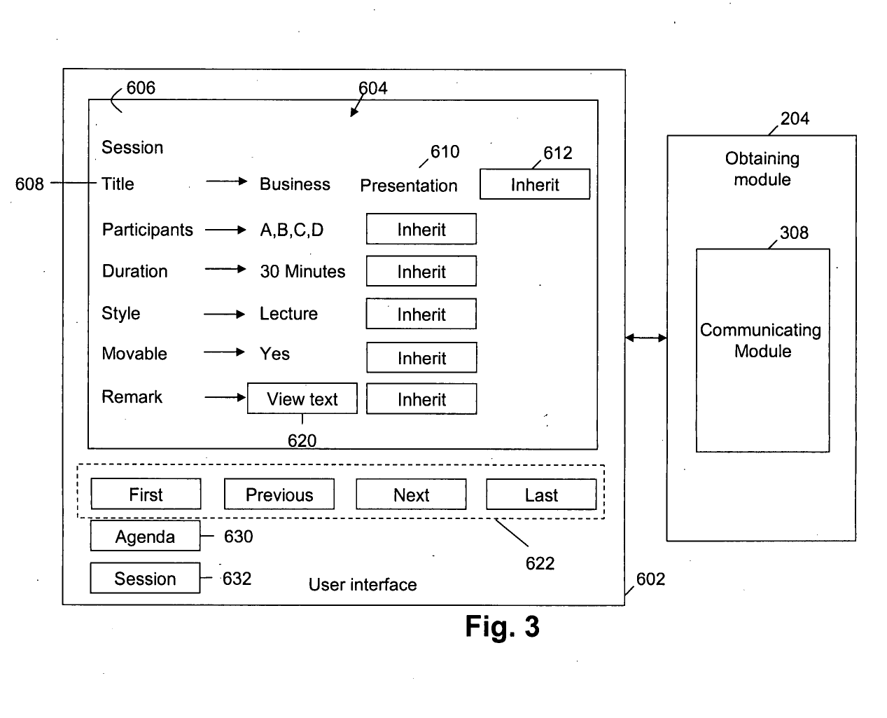

FIG. 3 illustrates basic features of a graphical user interface (GUI) 602 in a preferred embodiment of the invention. In FIG. 3, obtaining module 204 includes a communicating module 308 that receives input from and sends output to the GUI. Other designs are possible. GUI 602 includes an area 606 for displaying session or agenda parameter information. Selection of session parameter information can be by navigation buttons at and area 622, after the session mode is selected by a button 632. Agenda parameters can be selected for display by using button 630. Note that any number and type of controls can be used in other designs. The preferred embodiment uses a typical keyboard and mouse-and-pointer approach.

The session number of the currently displayed session parameters is shown at area 606 along with an indication that the parameters are session parameters. The user can move to a first session parameters by hitting either the “Previous” or “First” buttons and can move to a third session parameters by pressing the “Next” button. Assuming there are five sessions in the agenda, the user can jump to the fifth session's parameters by pressing the “Last” button.

Within an area 604 are shown the parameters and parameter values associated with the second session. The names of the parameters are along the left column as “Title,” “Participants,” “Duration,” “Style,” “Movable,” and “Remark.” Other embodiments can use any different parameters and arrangements as desired. The values for the parameters are shown after the right-pointing arrow. For example, the value of the “Title” parameter is “Business Presentation.” The value can be changed by clicking on the parameter's value and using a keyboard to enter a new value. Values can also be obtained from other session parameters or from agenda parameters by using an “Inherit” button 612. Note that each parameter has an associated “Inherit” button 612. Other GUI designs can use different approaches such as by right clicking on a parameter to allow inheritance, highlighting a parameter and then clicking an “Inherit” button, etc. Each other parameter value can be adjusted or assigned in a similar manner. Although not shown in FIG. 3, additional enhancements can be provided such as by allowing a user to copy an entire set of parameters (e.g., parameter names and values) from a session or agenda into a current session. The “Remark” parameter has a text value that is viewable upon depressing the a “View Text” button 620. Other controls can be provided. Table 1 below, shows a complete agenda of 5 sessions.

TABLE I
1. Introduction Session
Required Participants: A, B, C, F
Duration: 15 minutes
Conference Style: Lecture style
Movable: no
Remark: Team lead (A), CEO (F) welcome customer (B, C) and leaves
after the introduction to join other meeting.
2. Business Presentation
Required Participants: A, B, C, D
Duration: 30 minutes
Conference Style: Lecture style
Movable: yes
Remark: PM Manager (D) joins to present business side
3. Technical presentation
Required Participants: A, C, E
Duration: 30 minutes
Conference Style: Lecture style
Movable: yes
Remark: Lead engineer (F) to present technical side
4. Question and Answers
Required Participants: A, B, C, D, E, F
Duration: 30 minutes
Conference Style: Free style
Movable: no
Remark: All participants are required for questions and answers
5. Discussion
Required Participants: A, B, C, D, E, F
Duration: 15 minutes
Conference style: Free style
Movable: no
Remark: All participants are required for discussion

Once the parameters are assigned, communicating module 308 informs the participants of the conference about the timings of the conference sessions for which the subscriptions have been acquired. In an embodiment of the invention, communicating module 308 notifies the participants about the upcoming conference session, if there is any modification in the timing of the upcoming session. In another embodiment of the invention, communicating module 308 send reminders to the participants of the conference about their conference session timings. Communicating module 308 communicates with the participants of the conference after receiving a signal from signal sender 208, present in moderation system 202.

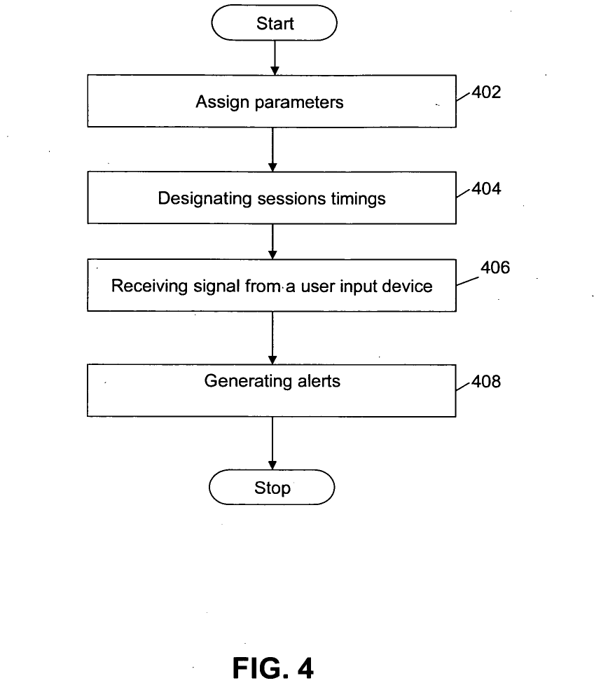

FIG. 4 illustrates a flowchart of a method for automatic scheduling of a conference, in accordance with an embodiment of the invention. At step 402, agenda parameters that have been obtained by obtaining module 204 are assigned to the conference agenda. Assigning module 206 interacts with obtaining module 204 and assigns parameters to the agenda. Various agenda parameters can be the length of the agenda, the name or number of the conference room, the conference credentials, and so forth. Once the parameters of the agenda are assigned at step 404, assigning module 206 assigns parameters to the each of the conference sessions. Various session parameters include the conference style, the list of conference participants, the time and duration of the availability of the participants of the conference and their communication addresses, and so forth. When the parameters of the session have been assigned to the conference sessions, each of the conference sessions are allocated time with respect to another session, on the basis of the assigned parameters. After the sessions have been allocated timings, at step 406, a signal is sent by signal sender 208, present in user interface 104, to specify the state of the conference session. Conference session parameters can include the starting time of a session, the predetermined end time of a session, a change in the time of availability of the participants of the upcoming sessions, a list of one or more needed session resources, etc. In general, any quality or characteristic of a conference can be represented as a session parameter. Once the signal is sent by signal sender 208, alert generator 210 generates alerts to notify conference moderator 108 whether any modification is required in the ongoing session or in upcoming sessions.

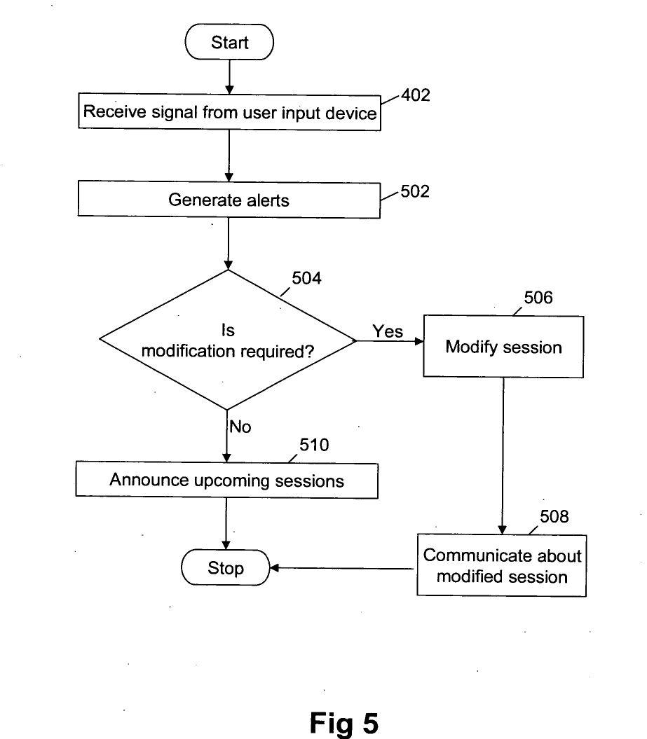

FIG. 5 illustrates a flowchart of a method for the generation of alerts, in accordance with an embodiment of the invention. At step 406, a signal is sent from signal sender 208, specifying the state of the session. The state of the conference session can include the starting time of a session, the predetermined end time of a session, a change in the time of availability of the participants of the upcoming sessions, a change in the availability of conference resources will be available, and so forth. Alert generator 210 receives the signal from signal sender 208, and an alert is generated at step 502 to notify conference moderator 108 that a session is near its predetermined ending time. At step 504, conference moderator 108 checks whether it is required to modify the duration of the ongoing session. If a modification is required in the duration of an ongoing session, then, at step 506, it is modified by conference moderator 108, to deal with any unforeseen problem. Conference moderator 108 can shorten or extend the duration of an ongoing session, as required. Once the modification is carried out by conference moderator 108, a signal is sent through signal sender 208 to communicating module 308 and at step 508 communicating module 308 informs the participants of the upcoming session about the change in their session timings. If a modification is not required in the duration of an ongoing session, and the next session can start at the allocated time, then, at step 510, a signal is generated to specify the end of the ongoing session.

In an embodiment of the invention, an alert is generated when there is a change in the availability of conference resources or in the time of the availability of participants of the upcoming session. In this case, conference moderator 108 can modify the allocated time of a session with respect to another session, if the upcoming session is dynamic in nature, which implies that the session can be moved from one sequence to another. The example illustrates that dynamic sessions can be moved to change the sequence of the sessions within the conference. For example, the sequence of business participation and technical participation may be interchanged to accommodate required participants and conference resources. It also indicates how various participants can join and leave the conference, to fulfill other commitments during that time.

Embodiments of the invention have the advantage of efficiently using communication resources in a conference. The invention divides a conference into sessions, according to one or more conference parameters, enabling participants to only subscribe for a selected session. This helps them save time, as they do not have to attend those parts of the conference that are of no interest or value to them. Various embodiments of the invention also provide the flexibility of rearranging the sequence of the sessions according to the availability of the participants and conference resources.

Although the invention has been discussed with respect to specific embodiments thereof, these embodiments are merely illustrative, and not restrictive, of the invention.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for organizing a plurality of electronic meetings into an agenda, the method comprising:
accepting a signal from a user input device to specify a first session;
accepting a signal from the user input device to specify a second session;
assigning an agenda parameter to the agenda, wherein the agenda parameter is associated with the first and second sessions; and
displaying session parameters for the first and second sessions so that the first and second sessions have common agenda parameters but different session parameters.

2. The method of claim 1, wherein an agenda parameter includes a conference identifier.

3. The method of claim 1, wherein an agenda parameter includes a conference room name.

4. The method of claim 1, wherein an agenda parameter includes an agenda length.

5. The method of claim 1, wherein an agenda parameter includes conference credentials.

6. The method of claim 1, wherein a session parameter includes a conference style.

7. The method of claim 6, wherein a conference style includes one of the following types: introduction, question and answer, free style.

8. The method of claim 1, wherein a session parameter includes a list of invitees.

9. The method of claim 8, further comprising:
defining a global list of invitees having a plurality of names;
associating the names with each of the sessions in the agenda; and
accepting a signal from a user input device to modify at least one name associated with one session.

10. The method of claim 1, wherein a session parameter includes a session description.

11. The method of claim 1, further comprising:
designating a session as fixed in time with respect to another session.

12. The method of claim 1, further comprising:
generating an alert when a session is near a predetermined ending time.

13. The method of claim 1, further comprising:
generating a message to indicate the start of a next session.

14. The method of claim 1, wherein an electronic meeting includes a teleconference.

15. The method of claim 1, wherein an electronic meeting includes Internet communication.

16. The method of claim 15, wherein the electronic meeting includes screen sharing via a web browser.

17. The method of claim 16, wherein the electronic meeting includes a webex meeting.

18. A system for organizing a plurality of electronic meetings into an agenda, the system comprising:
means for accepting a signal from a user input device to specify a first session;
means for accepting a signal from the user input device to specify a second session;
means for assigning an agenda parameter to the agenda, wherein the agenda parameter is associated with the first and second sessions; and
means for displaying session parameters for the first and second sessions so that the first and second sessions have common agenda parameters but different session parameters.

19. A system for organizing a plurality of electronic meetings into an agenda, the system comprising:
an obtaining module for obtaining parameters
an assigning module for assigning parameters;
a signal sender for sending signal on a user input device; and
an alert generator for generating alerts on a user input device.

20. An apparatus for organizing a plurality of electronic meetings into an agenda, the apparatus comprising
a processing system including a processor coupled to a display and user input device; and
a machine-readable medium including instructions executable by the processor comprising
one or more instructions for accepting a signal from a user input device to specify a first session;
one or more instructions for accepting a signal from the user input device to specify a second session;
one or more instructions for assigning an agenda parameter to the agenda, wherein the agenda parameter is associated with the first and second sessions; and
one or more instructions for displaying session parameters for the first and second sessions so that the first and second sessions have common agenda parameters but different session parameters.

21. A machine-readable medium including instructions executable by the processor comprising
one or more instructions for accepting a signal from a user input device to specify a first session;
one or more instructions for accepting a signal from the user input device to specify a second session;
one or more instructions for assigning an agenda parameter to the agenda, wherein the agenda parameter is associated with the first and second sessions; and
one or more instructions for displaying session parameters for the first and second sessions so that the first and second sessions have common agenda parameters but different session parameters.
